(19) United States
(12) Patent Application Publication
(10) Pub. No.: US 2026/0205526 A1
(43) Pub. Date: Jul. 16, 2026

(54) PROPAGATION OF DATA IN DISTRIBUTED CACHES

(71) Applicant: Nokia Solutions and Networks Oy, Espoo (FI)

(72) Inventors: Andrea ENRICI, Massy (FR); Lionel NATARIANNI, Massy (FR)

(21) Appl. No.: 19/134,945

(22) PCT Filed: Dec. 7, 2022
(86) PCT No.: PCT/IB2022/061899

§ 371 Date: Jun. 2, 2025

(51) Int. Cl. H04L 67/5683; H04L 67/12

(52) U.S. Cl. CPC H04L 67/5683; H04L 67/12

(57) ABSTRACT

Method comprising: determining whether a first edge node of an edge network receives a cache request, wherein the cache request requests the first edge node to cache data received from a movable device; calculating at least one of the following in response to determining that the first edge node receives the cache request: a lifetime for the data, or a maximum topological distance such that the data must not be transmitted from the first edge node in the edge network farther than the maximum topological distance in a direction away from the first edge node; transmitting the data along with the at least one of the maximum topological distance and the lifetime via a first edge of the edge network to a second edge node of the edge network, wherein the first edge terminates at the first edge node and the second edge node.

### FIELD OF THE INVENTION

The present disclosure relates to distributed caches, and in particular to propagation of data in distributed caches.

### BACKGROUND

The 5G Automotive Association (5GAA) 5GAA aims to bring automotive and telecommunications companies together to harmonize and accelerate the introduction of intelligent transport and communication solutions. A 5GAA white paper considers new functions, including:
Sharing sensor data, such as video from the car in front
Control information to allow vehicles to drive in close formation (platooning), saving road space
Exchanging vehicle trajectories to prevent collisions

These advanced examples of Vehicle2Vehicle and Vehicle2Infrastructure communications are feasible thanks to 5G technology, for example.

Intelligent Transportation Systems (ITS) aim at reducing urban transit congestion by maximizing the number of passengers transported per hour while optimizing the total cost of the solution and offering the utmost safety for human drivers.

### SUMMARY

According to a first aspect of the disclosure, there is provided an apparatus comprising:
one or more processors, and memory storing instructions that, when executed by the one or more processors, cause the apparatus to perform:
determining whether a first edge node of an edge network receives a cache request, wherein the cache request requests the first edge node to cache data received from a movable device;
calculating at least one of the following in response to determining that the first edge node receives the cache request: a lifetime for the data, or a maximum topological distance such that the data must not be transmitted from the first edge node in the edge network farther than the maximum topological distance in a direction away from the first edge node;
transmitting the data along with the at least one of the maximum topological distance and the lifetime via a first edge of the edge network to a second edge node of the edge network, wherein
the edge network connects a plurality of edge nodes including the first edge node and the second edge node by respective edges;
each of the edges connects logically, in the edge network, respective two of the edge nodes directly with each other such that each of the edges terminates logically at the respective two edge nodes without any intermediate edge node;
according to a stored topology of the edge network, the first edge terminates at the first edge node and the second edge node.

According to a second aspect of the disclosure, there is provided an apparatus comprising:
one or more processors, and memory storing instructions that, when executed by the one or more processors, cause the apparatus to perform:
determining whether a first edge node of an edge network receives a cache request, wherein the cache request requests the first edge node to cache data received from a movable device;
in response to determining that the first edge node receives the cache request: calculating a maximum topological distance such that the data must not be transmitted from the first edge node in the edge network farther than the maximum topological distance in a direction away from the first edge node;
determining one or more second edge nodes, wherein, according to a stored topology of the edge network, each of the one or more second edge nodes is not farther away from the first edge node than the maximum topological distance;
transmitting the data to each of the second edge nodes, wherein
the edge network connects a plurality of edge nodes including the first edge node and the one or more second edge nodes by respective edges;
each of the edges connects logically, in the edge network, respective two of the edge nodes directly with each other such that each of the edges terminates logically at the respective two edge nodes without any intermediate edge node.

For the apparatus according to any of the first or second aspects, one or more of the following may apply:

The instructions, when executed by the one or more processors, may cause the apparatus to perform:
the determining the one or more second edge nodes by determining all the second edge nodes, wherein, according to the stored topology, each of all the second edge nodes is not farther away from the first edge node than the maximum topological distance.

The instructions, when executed by the one or more processors, may further cause the apparatus to perform:
calculating a lifetime of the data in response to determining that the first edge node receives the cache request;
transmitting the lifetime along with the data to each of the second edge nodes.

The instructions, when executed by the one or more processors, may further cause the apparatus to perform:
caching the data in a cache of the first edge node in response to determining that the first edge node receives the cache request.

The instructions, when executed by the one or more processors, may further cause the apparatus to perform:
determining whether the lifetime of the data has expired; and at least one of the following:
inhibiting the caching the data in the cache of the first edge node in response to determining that the lifetime of the data has expired, or
removing the data from the cache of the first edge node in response to determining that the lifetime of the data has expired.

The instructions, when executed by the one or more processors, may cause the apparatus to perform:
the calculating the maximum topological distance based on at least one of: a status of the movable device or a status of an environment of the movable device.

The status of the movable device may comprise at least one of the following: a location of the movable device, a current speed of the movable device, or a previous speed of the movable device, or a current acceleration of the movable device, or a previous acceleration of the movable device.

The status of the environment of the movable device may comprise at least one of the following: a current congestion level at the location of the movable device, or a current congestion level on a route predicted for the movable device, or a previous congestion level at the location of the movable device, or a previous congestion level on the route predicted for the movable device, or an expected congestion level on the route predicted for the movable device, or an admissible speed at the location of the movable device, or an admissible speed on the route predicted for the movable device.

The instructions, when executed by the one or more processors, may further cause the apparatus to perform:
determining whether the maximum topological distance is smaller than a topological distance to the second edge node from the first edge node, wherein, according to the stored topology, the second edge node is a nearest neighbor of the first edge node;
inhibiting the transmitting the data in response to determining that the maximum topological distance is smaller than the topological distance to the second edge node from the first edge node.

The instructions, when executed by the one or more processors, may further cause the apparatus to perform:
determining whether the lifetime of the data has expired;
inhibiting the transmitting the data in response to determining that the lifetime of the data has expired.

According to a third aspect of the invention, there is provided an apparatus comprising:
one or more processors, and memory storing instructions that, when executed by the one or more processors, cause the apparatus to perform:
determining whether a second edge node of an edge network receives a cache request transmitted from a first edge node via a first edge, wherein
the edge network connects a plurality of edge nodes including the first edge node and the second edge node by respective edges including the first edge and a second edge;
each of the edges connects logically, in the edge network, respective two of the edge nodes directly with each other such that each of the edges terminates logically at the respective two edge nodes without any intermediate edge node;
the first edge terminates at the first edge node and the second edge node;
the second edge terminates at the second edge node and a third edge node different from the first edge node;
the cache request comprises data related to a movable device and at least one of the following: a lifetime of the data, or a maximum topological distance, wherein the data must not be transmitted from the first edge node in the edge network farther than the maximum topological distance in a direction away from the first edge node;
and the instructions, when executed by the one or more processors, further cause the apparatus to perform:
determining whether the lifetime of the data has expired in response to determining that the second edge node receives the cache request comprising the lifetime;
inhibiting transmitting the data via the second edge in response to determining that the second edge node receives the cache request comprising the lifetime and that the lifetime of the data has expired;
determining whether the maximum topological distance indicates that the data have been transmitted for the maximum topological distance by the transmitting the data from the first edge node via the first edge in response to determining that the second edge node receives the cache request comprising the maximum topological distance;
inhibiting the transmitting the data via the second edge in response to determining that the second edge node receives the cache request comprising the maximum topological distance and that the greatest number of edges indicates that the data have been transmitted for the maximum topological distance by the transmitting the data from the first edge node via the first edge.

The instructions, when executed by the one or more processors, may further cause the apparatus to perform:
caching the data in a cache of the second edge node in response to determining that the second edge node receives the cache request comprising the lifetime and that the lifetime of the data has not expired.

The instructions, when executed by the one or more processors, may further cause the apparatus to perform:
decrementing the maximum topological distance by a distance corresponding to the first edge in response to determining that the second edge node receives the cache request comprising the maximum topological distance and that the maximum topological distance does not indicate that the data have been transmitted for at least the maximum topological distance by the transmitting the data from the first edge node via the first edge;
transmitting the data along with the decremented maximum topological distance via the second edge in response to determining that the maximum topological distance does not indicate that the data have been transmitted for at least the maximum topological distance by the transmitting the data from the first edge node via the first edge.

The instructions, when executed by the one or more processors, may further cause the apparatus to perform:
transmitting the lifetime along with the data via the second edge in response to determining that the second edge node receives the cache request comprising the lifetime and that the lifetime of the data has not expired.

The instructions, when executed by the one or more processors, may further cause the apparatus to perform:
inhibiting caching the data in a cache of the second edge node in response to determining that the second edge node receives the cache request comprising the lifetime and that the lifetime of the data has expired;

The instructions, when executed by the one or more processors, may further cause the apparatus to perform:
determining whether previous data related to the movable device are cached in the cache of the second edge node;
overwriting the previous data related to the movable device by the data related to the movable device comprised in the cache request in response to determining that the previous data related to the movable device are cached in the cache of the second edge node.

In the apparatus according to any of the first, second, or third aspects, the maximum topological distance may be indicated as a greatest number of edges, wherein the data must not be transmitted in the edge network on more than the greatest number of edges in the direction away from the first edge node.

According to a fourth aspect of the invention, there is provided a method comprising:
determining whether a first edge node of an edge network receives a cache request, wherein the cache request requests the first edge node to cache data received from a movable device;
calculating at least one of the following in response to determining that the first edge node receives the cache request: a lifetime for the data, or a maximum topological distance such that the data must not be transmitted from the first edge node in the edge network farther than the maximum topological distance in a direction away from the first edge node;
transmitting the data along with the at least one of the maximum topological distance and the lifetime via a first edge of the edge network to a second edge node of the edge network, wherein
the edge network connects a plurality of edge nodes including the first edge node and the second edge node by respective edges;
each of the edges connects logically, in the edge network, respective two of the edge nodes directly with each other such that each of the edges terminates logically at the respective two edge nodes without any intermediate edge node;
according to a stored topology of the edge network, the first edge terminates at the first edge node and the second edge node.

According to a fifth aspect of the invention, there is provided a method comprising:
determining whether a first edge node of an edge network receives a cache request, wherein the cache request requests the first edge node to cache data received from a movable device;
in response to determining that the first edge node receives the cache request: calculating a maximum topological distance such that the data must not be transmitted from the first edge node in the edge network farther than the maximum topological distance in a direction away from the first edge node;
determining one or more second edge nodes, wherein, according to a stored topology of the edge network, each of the one or more second edge nodes is not farther away from the first edge node than the maximum topological distance;
transmitting the data to each of the second edge nodes, wherein
the edge network connects a plurality of edge nodes including the first edge node and the one or more second edge nodes by respective edges;
each of the edges connects logically, in the edge network, respective two of the edge nodes directly with each other such that each of the edges terminates logically at the respective two edge nodes without any intermediate edge node.

For the method according to any of the fourth or fifth aspects, one or more of the following may apply:

The determining the one or more second edge nodes may be performed by determining all the second edge nodes, wherein, according to the stored topology, each of all the second edge nodes is not farther away from the first edge node than the maximum topological distance.

The method may further comprise:
calculating a lifetime of the data in response to determining that the first edge node receives the cache request;
transmitting the lifetime along with the data to each of the second edge nodes.

The method may further comprise:
caching the data in a cache of the first edge node in response to determining that the first edge node receives the cache request.

The method may further comprise:
determining whether the lifetime of the data has expired; and at least one of the following:
inhibiting the caching the data in the cache of the first edge node in response to determining that the lifetime of the data has expired, or
removing the data from the cache of the first edge node in response to determining that the lifetime of the data has expired.

The maximum topological distance may be calculated based on at least one of: a status of the movable device or a status of an environment of the movable device.

The status of the movable device may comprise at least one of the following: a location of the movable device, a current speed of the movable device, or a previous speed of the movable device, or a current acceleration of the movable device, or a previous acceleration of the movable device.

The status of the environment of the movable device may comprise at least one of the following: a current congestion level at the location of the movable device, or a current congestion level on a route predicted for the movable device, or a previous congestion level at the location of the movable device, or a previous congestion level on the route predicted for the movable device, or an expected congestion level on the route predicted for the movable device, or an admissible speed at the location of the movable device, or an admissible speed on the route predicted for the movable device.

The method may further comprise:
determining whether the maximum topological distance is smaller than a topological distance to the second edge node from the first edge node, wherein, according to the stored topology, the second edge node is a nearest neighbor of the first edge node;
inhibiting the transmitting the data in response to determining that the maximum topological distance is smaller than the topological distance to the second edge node from the first edge node.

The method may further comprise:
determining whether the lifetime of the data has expired;
inhibiting the transmitting the data in response to determining that the lifetime of the data has expired.

According to a sixth aspect of the invention, there is provided a method comprising:
determining whether a second edge node of an edge network receives a cache request transmitted from a first edge node via a first edge, wherein
the edge network connects a plurality of edge nodes including the first edge node and the second edge node by respective edges including the first edge and a second edge;
each of the edges connects logically, in the edge network, respective two of the edge nodes directly with each other such that each of the edges terminates logically at the respective two edge nodes without any intermediate edge node;
the first edge terminates at the first edge node and the second edge node;
the second edge terminates at the second edge node and a third edge node different from the first edge node;
the cache request comprises data related to a movable device and at least one of the following: a lifetime of the data, or a maximum topological distance, wherein the data must not be transmitted from the first edge node in the edge network farther than the maximum topological distance in a direction away from the first edge node;
and the method further comprises:
determining whether the lifetime of the data has expired in response to determining that the second edge node receives the cache request comprising the lifetime;
inhibiting transmitting the data via the second edge in response to determining that the second edge node receives the cache request comprising the lifetime and that the lifetime of the data has expired;
determining whether the maximum topological distance indicates that the data have been transmitted for the maximum topological distance by the transmitting the data from the first edge node via the first edge in response to determining that the second edge node receives the cache request comprising the maximum topological distance;
inhibiting the transmitting the data via the second edge in response to determining that the second edge node receives the cache request comprising the maximum topological distance and that the greatest number of edges indicates that the data have been transmitted for the maximum topological distance by the transmitting the data from the first edge node via the first edge.

The method may further comprise:
caching the data in a cache of the second edge node in response to determining that the second edge node receives the cache request comprising the lifetime and that the lifetime of the data has not expired.

The method may further comprise:
decrementing the maximum topological distance by a distance corresponding to the first edge in response to determining that the second edge node receives the cache request comprising the maximum topological distance and that the maximum topological distance does not indicate that the data have been transmitted for at least the maximum topological distance by the transmitting the data from the first edge node via the first edge;
transmitting the data along with the decremented maximum topological distance via the second edge in response to determining that the maximum topological distance does not indicate that the data have been transmitted for at least the maximum topological distance by the transmitting the data from the first edge node via the first edge.

The method may further comprise:
transmitting the lifetime along with the data via the second edge in response to determining that the second edge node receives the cache request comprising the lifetime and that the lifetime of the data has not expired.

The method may further comprise:
inhibiting caching the data in a cache of the second edge node in response to determining that the second edge node receives the cache request comprising the lifetime and that the lifetime of the data has expired;

The method may further comprise:
determining whether previous data related to the movable device are cached in the cache of the second edge node;
overwriting the previous data related to the movable device by the data related to the movable device comprised in the cache request in response to determining that the previous data related to the movable device are cached in the cache of the second edge node.

In the method according to any of the fourth, fifth, and sixth aspects, the maximum topological distance may be indicated as a greatest number of edges, wherein the data must not be transmitted in the edge network on more than the greatest number of edges in the direction away from the first edge node.

Each of the methods of the fourth, fifth, or sixth aspects may be a method of data propagation.

According to a seventh aspect of the invention, there is provided a computer program product comprising a set of instructions which, when executed on an apparatus, is configured to cause the apparatus to carry out the method according to any of the fourth, fifth, or sixth aspects. The computer program product may be embodied as a computer-readable medium or directly loadable into a computer.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 illustrates a logical architecture of a cache unit according to some example embodiments;

FIG. 2 shows an apparatus according to an example embodiment;

FIG. 3 shows a method according to an example embodiment;

FIG. 4 shows an apparatus according to an example embodiment;

FIG. 5 shows a method according to an example embodiment;

FIG. 6 shows an apparatus according to an example embodiment;

FIG. 7 shows a method according to an example embodiment; and

FIG. 8 shows an apparatus according to an example embodiment.

### DETAILED DESCRIPTION

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details. Moreover, it is to be understood that the apparatus is configured to perform the corresponding method, although in some cases only the apparatus or only the method are described.

By means of example, some requirements on an ITS may be:
Vehicles are controlled by an Edge hosting applications emitting control messages.
Devices (Vehicles) must be connected to a single Edge at any given time
Scalability: thousands of Edges, hundred devices per Edge
maximum End-to-End latency <30 ms for platooning vehicles (ETSI TS 122 186 V16.2.0)

The last one of these requirement is very stringent. Therefore, the controllers should be located as close as possible to the vehicles and the numbers of hops should be limited. Current objective is a latency of less than 20 to 30 ms with clock tick=10 ms, wherein the clock tick denotes a minimum period of time used by the ITS cloud supervisor to schedule operations.

In an ITS project, one or more of the following control information and data may be exchanged:
Vehicle-to-Edge data: telemetry data like current position, current speed, current acceleration
Edge-to-Vehicle data: control signals to assist vehicle navigation (e.g., anticipate road congestion ahead)
Edge-to-Edge data: data related to the variation of vehicles positions, speed, acceleration, etc.

Logically, an ITS may be based on a network of roads, such as a network of dedicated lanes on existing roads (physical road network). I.e., the ITS may be considered as an edge network connecting edge nodes (controllers) by edges (e.g. roads). In the example that the edges correspond to roads, the topology of the edge network may correspond to the topology of the roads. However, this correspondence is not mandatory. For example, the ITS (edge network) may have some edges for which a corresponding road does not exist, or there may be some roads, which do not correspond to an edge of the edge network.

Each physical node (i.e. edge node (controller) of the telecommunication network) corresponds bijectively to an edge node. Therefore, for the present disclosure, the terms “physical node” (and similar terms, such as controller) and “edge node” may be used interchangeably, unless otherwise indicated or made clear from the context.

The edge nodes make up logically an edge network, wherein the edge nodes are connected with each other by (logical) edges. Each edge connects directly two edge nodes, i.e., the edge terminates at the two edge nodes and does not have any intermediate edge nodes. An edge in the edge network may correspond to a physical link between the corresponding physical nodes, or a physical link between the corresponding physical nodes may not exist. A physical link between two physical nodes may correspond to an edge between the corresponding two edge nodes in the edge network, or an edge between the corresponding two edge nodes may not exist in the edge network. In some example embodiments, each of the edges corresponds to a respective physical link and vice versa, i.e. the edge network made up by the edge nodes and edges corresponds to the physical network made up by the physical nodes (e.g. controllers) and physical connections.

The data sent by vehicles to edge nodes changes dynamically as vehicles move in the physical road network. The data received from a vehicle by an edge node at a certain time may be useful for other edge nodes, too. Thus, the edge node may propagate the data within the edge network. That is, it might be advisable to replicate the data autonomously within the edge network (dynamic data replication). However, if the data of many vehicles are propagated through the entire edge network (or a larger part thereof), the edge network may become congested, and/or some of the data may be transmitted to edge nodes which do not benefit from these specific data.

In order to prevent congestion of the edge network and/or to avoid unnecessary data transmission, some example embodiments exploit at least one of the following: a spatial locality of the data, or a temporal locality of the data. The corresponding processes may also be denoted “geo-aware management” of the data.

“Spatial locality” of the data means that the data received from vehicle V at edge node E is likely to be reused in neighboring edge nodes of E. The maximum topological distance d of the neighboring edge nodes which may likely reuse the data received from the vehicle V may vary according to several dynamic conditions (e.g., traffic, vehicle route). “Temporal locality” of the data means that the data sent by vehicle V to edge node E at time t is likely to be reused at time t+Δt. Δt may vary according to several dynamic conditions (e.g., traffic, vehicle route).

The dynamic conditions for the maximum topological distance d and the time Δt may be the same or different from each other. Each of the maximum topological distance d and the time Δt may depend on at least one of: a status of the vehicle, or a status of the environment of the vehicle. For instance, in urban scenarios, d (or Δt) is likely to be small as vehicles are more likely to change direction/route as opposed to high-ways, where d (or Δt) is likely to be larger (vehicles rarely change route and/or it takes a longer time before a vehicle takes again a route that was taken in the near past). The status of the vehicle may comprise, for example, one or more of a location of the vehicle, a current speed of the vehicle, or a previous speed of the vehicle, or a current acceleration of the vehicle, or a previous acceleration of the vehicle. The status of the environment of the vehicle may comprise, for example, one or more of a current congestion level at the location of the vehicle, or a current congestion level on a route predicted for the vehicle, or a previous congestion level at the location of the vehicle, or a previous congestion level on the route predicted for the vehicle, or an expected congestion level on the route predicted for the vehicle, or an admissible speed at the location of the vehicle, or an admissible speed on the route predicted for the vehicle.

Some example embodiments comprise a system of distributed caches, where a cache is located within an edge node and the caches are logically connected to each other by edges. The topology of the edge network is determined by the logical connections. The physical connection between any two edge nodes may correspond to the logical connection or may be different therefrom. The physical connection may be wireline or wireless (radio).

The data from one vehicle received by one edge node are stored (cached) in the cache of this edge node and may be further distributed to other edge nodes of the edge network. The distribution of the data may be controlled by means of a control layer that acts according to the topology of the edge network. Each edge network may store some information on the topology. Some information related to the topology (“depth tag”) may be transmitted along with the data to be replicated.

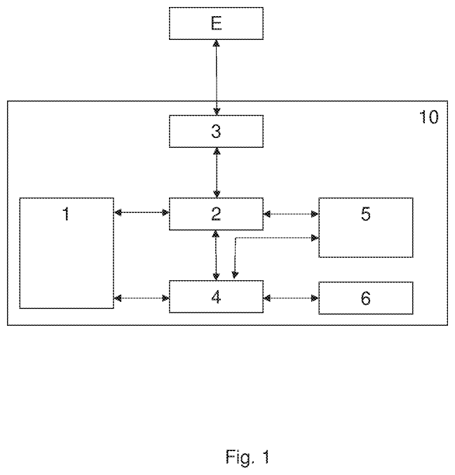

FIG. 1 represents a logical architecture of a cache unit 10 according to some example embodiments. Other logical architectures are feasible. The cache unit 10 is associated bijectively to an edge node E of the edge network. For example, the cache unit 10 may be considered as being a part of the edge node it is associated to. Logically, the cache unit 10 comprises an internal memory 1, a control unit 2, a communication buffer 3, a computation unit 4, an internal status register 5 and a library 6

The cached data are stored (cached) in the internal memory 1 (for example, in cache lines each representing a dataset and cache blocks each comprising plural cache lines). The internal memory may also be used to store the topology of the edge network. The topology may be used to manage cached content.

The Control Unit 2 is in charge of controlling the cache unit. Controlling the cache unit 10 may comprise, for example, one or more of processing requests for caching data, processing requests for retrieving cached data, transmitting data received in the requests for caching data to other edge nodes, updating the edge network's topology, updating of the library 6. The control unit 2 may receive/transmit the data or updates via one or more communication buffers 3.

The Computation Unit 4 is in charge of executing computations, such as computations related to the algorithms (described below) for the geo-aware management of the data received in requests for caching data. One or more internal control and status registers 5 are used for communication between the Control unit 2 and the Communication unit 4 (for example, to store commands from the Control unit to the Communication unit).

The Library 6 stores algorithms for the geo-aware cache management, e.g., algorithms for network traversal. The library 6 may be realized as one or more Look-Up Tables that correspond to the algorithms. As another option, the library 6 may store formulas corresponding to the algorithms.

The cache unit 10 may be physically realized by a computer and corresponding software to realize the functions of the internal memory 1, the control unit 2, the communication buffer 3, the computation unit 4, the internal status register 5 and the library 6. The computer may comprise one or more processors (e.g. CPU) and memory. One computer may physically realize one or more than one cache units 10 associated to respective edge units. The computer may comprise external memory. As another option, the cache unit may be fully or partly implemented by an ASIC.

The datasets stored in the internal memory 1 may comprise, in addition to the data (vehicle-to-edge data) received from a vehicle (identified by a vehicle ID), one or more of the following fields: data lifetime, topology tag, depth tag, or validity bit. Table 1 shows an example of such a dataset.

TABLE 1
Example of a dataset stored in the internal memory 1

| Vehicle | Vehicle-to- | Data | | Depth | Validity |
|---|---|---|---|---|---|
| ID | Edge data | lifetime | Topology tag | tag | bit |
| 0x123 | position, speed, | 1 s | edge node from | 2 | 1/0 |
| | acceleration, | | which the dataset | | |
| | . . . | | is received | | |

The data lifetime indicates the lifetime Δt of the dataset. The topology tag indicates the edge node from which the dataset is received. It may represent the edge node which received the vehicle-to-edge data from the vehicle, and/or it may represent the edge node which transmitted the vehicle-to-edge data to the present edge node. The validity tag indicates whether or not the dataset is still valid. If it is invalid (e.g. because the lifetime has expired), the dataset may be removed from the internal memory 1.

The depth tag indicates a maximum topological distance d. The data must not be transmitted in the edge network from the edge node associated to the cache unit (first edge node) farther than the maximum topological distance in a direction away from the associated edge node.

For example, the maximum topological distance d may be indicated as a greatest number of edges (i.e., logical connections between edge nodes) such that the vehicle-to-edge data must not be transmitted in the edge network on more than the greatest number of edges in the direction away from the first edge node. In this case, each of the edges in the topological network has a same topological distance (typically, the topological distance of each edge is 1). However, in some example embodiments, some edges of the edge network may have mutually different topological distances. For example, the topological distance may correspond to the physical (spatial) distance between the edge nodes terminating the respective edge. In case of different topological distances for different edges, the topological distance between two edge nodes may be determined by adding the topological distances of the edges of all paths between the two edge nodes and determining the smallest determined sum of the topological distances.

If a first edge node E receives a cache request requesting to cache (store) vehicle-to-edge data D received from a vehicle V, one or both of the following actions a) and b) may be performed by the cache unit 10 (in particular by the control unit 2 and the computation unit 4). In addition, it may cache (store) the vehicle-to-edge data D in the internal memory 1 of the cache unit associated to the first edge node E.
a) Calculate the maximum topological distance the data may be propagated from the first edge node E. For example, the maximum topological distance may correspond to a number of edges (i.e., logical connections between edge nodes) away from the first edge node E. As outlined above, the maximum topological distance may be calculated based on a status of the vehicle and a status of the environment of the vehicle. Typically, the higher the vehicle speed the longer the maximum topological distance that data may be propagated. Inversely, the higher the level of congestion on the road, the shorter the maximum topological distance. In an example embodiment, the maximum topological distance is retrieved from a Look-Up Table that is accessed by means of keys composed of pairs <vehicle-speed, congestion-level>.

The congestion-level (and other information on the environment of the vehicle) may be part of the control information that the network controller/orchestrator periodically sends to the edge nodes including the first edge node E. The speed of the vehicle (and other information on the status of the vehicle) may be comprised in the vehicle-to-edge data.
b) Calculate the lifetime of the data. The lifetime may be calculated similarly to the maximum topological distance. The larger the value of the lifetime, the longer the data will reside in a cache. A LUT can also be used for this purpose. In some example embodiments, the maximum topological distance and/or the vehicle speed and/or the congestion level may be used as a key for accessing the LUT. The LUT may be updated periodically by means of the network controller/orchestrator.

In some example embodiments, the maximum topological distance may be calculated first, and based on the maximum topological distance, the lifetime may be calculated. In other example embodiments, the lifetime may be calculated first and, based on the lifetime, the maximum topological distance may be calculated. In some example embodiments, the lifetime and the maximum topological distance may be calculated independently from each other. These calculations may be performed in an arbitrary sequence or fully or partly in parallel.

Then, the first edge node E may transmit the vehicle-to edge data D to other edge nodes. For the transmission to other edge nodes, there are two options, depending on implementation or configuration:

### Option 1:

The first edge node E knows the network topology such that it can determine edge nodes within the maximum topological distance. The first edge node E may determine all the edge nodes within the maximum topological distance or a subset thereof. For example, the number of edge nodes to be determined may be limited, or some edge nodes may be excluded from being determined for other reasons. Then the first edge node E transmits the vehicle-to-edge data D (along with the lifetime if the same is calculated) to the determined edge nodes within the maximum topological distance. The determined edge nodes within the maximum topological distance do not propagate the vehicle-to-edge data any further.

### Option 2:

The first edge node E sends the vehicle-to-edge data D along with the maximum topological distance (and the lifetime if the same is determined) to its nearest neighbor according to the network topology. A nearest neighbor is connected to the first edge node E by one edge (i.e., a logical connection) terminating at the nearest neighbor and the first edge node E.

The actions performed by each of the nearest neighbors according to the option 2 may be as follows:

The nearest neighbor calculates a new maximum topological distance by subtracting the topological distance between the first edge node E and the nearest neighbor from the received maximum topological distance. For example, if the maximum topological distance is indicated as a greatest number of edges, the nearest neighbor decrements the greatest number of edges by 1 to obtain a new greatest number of edges. The nearest neighbor determines whether the new maximum topological distance is larger than the topological distance to its nearest neighbors in a direction away from the first edge node E. For example, if the maximum topological distance is indicated as a greatest number of edges, the nearest neighbor determines whether the new maximum topological distance is larger than 0. If the new maximum topological distance is equal to or larger than the topological distance to at least one of its nearest neighbors in a direction away from the first edge node E, the nearest neighbor transmits the vehicle-to-edge data D along with the new maximum topological distance to this at least one nearest neighbor. If the new maximum topological distance is smaller than the topological distance to each of its nearest neighbors in the direction away from the first edge node E, the nearest neighbor does not transmit the vehicle-to-edge data D any further.

According to both options 1 and 2, the vehicle-to-edge data D may be propagated to all edge nodes (or a subset thereof) within the maximum topological distance from the first edge node E but not to edge nodes beyond the maximum topological distance. Thus, unnecessary data transmission may be avoided and congestion of the edge network may be prevented.

If the first edge node E determines the lifetime and transmits the lifetime to the other edge nodes, each of the edge nodes may check if the lifetime has expired. If the lifetime has not expired, the respective edge node may propagate the vehicle-to-edge data D to further edge nodes. If the lifetime has expired, the respective edge node does not propagate the vehicle-to-edge data D any further and does not cache (store) the vehicle-to-edge data D. Each edge node may check (e.g. periodically or trigger based) whether it stores any vehicle-to-edge data having an expired lifetime. If it stores vehicle-to-edge data having an expired lifetime, the respective edge node may remove the corresponding dataset from the memory of the cache unit associated to the edge node.

If a propagation of the vehicle-to-edge data from a first edge node to a second edge node is inhibited by at least one of the maximum topological distance or the lifetime, the first edge node does not propagate the vehicle-to-edge data to the second edge node.

If a first edge node has to propagate the vehicle-to-edge data D to plural second edge nodes, the first edge node may transmit the vehicle-to-edge data D to the plural second edge nodes fully or partly in parallel or in an arbitrary sequence. For example, the sequence may correspond to an eccentricity of the second edge nodes in the edge network. The first edge node may transmit to the least eccentric edge nodes first or to the most eccentric edge nodes first. Eccentricity is a measure of centrality of an edge node in a graph (edge network). It is the greatest distance between an edge node and any other edge node in the graph, in terms of the number of edges on the shortest path between the two edge nodes. An algorithm to compute eccentricity of an edge node is as follows: for each edge node n in the graph, compute all shortest paths to all other edge nodes and store these shortest paths in a list L. The length of the greatest one among the shortest paths is a measure of the eccentricity. For example, the eccentricity may belong to the topology information updated by the controller or orchestrator of the edge network, or the edge node may calculate the eccentricity of the other edge nodes based on the topology of the edge network.

If a first edge node E receives vehicle-to-edge data for a vehicle (either from the vehicle or from another edge node), the first edge node may check if it has already cached previous vehicle-to-edge data for the vehicle. This may happen if, for instance, the vehicle that previously passed by the first edge node E makes a circular detour and passes twice by the first edge node E. In this case, the first edge node E may remove the previous vehicle-to-edge data, store the new vehicle-to-edge data, and propagate the new vehicle-to-edge data as described hereinabove, based on one or both of the maximum topological distance and the lifetime.

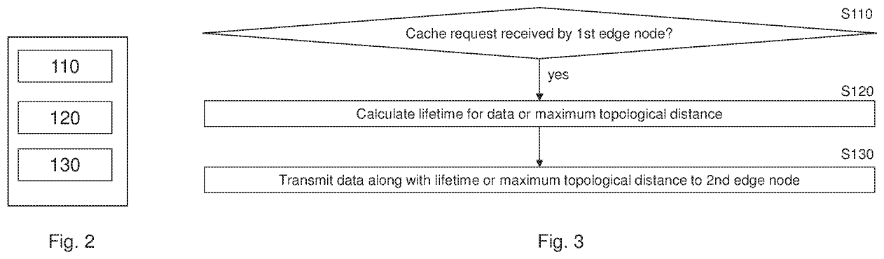

FIG. 2 shows an apparatus according to an example embodiment of the invention. The apparatus may be a cache unit or an element thereof (such as a control unit of the cache unit). FIG. 3 shows a method according to an example embodiment of the invention. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises means for determining 110, means for calculating 120, and means for transmitting 130. The means for determining 110, means for calculating 120, and means for transmitting 130 may be a determining means, calculating means, and transmitting means, respectively. The means for determining 110, means for calculating 120, and means for transmitting 130 may be a determiner, calculator, and transmitter, respectively. The means for determining 110, means for calculating 120, and means for transmitting 130 may be a determining processor, calculating processor, and transmitting processor, respectively.

The means for determining 110 determines whether a first edge node of an edge network receives a cache request (S110). The cache request requests the first edge node to cache data received from a movable device. The edge network connects a plurality of edge nodes including the first edge node and a second edge node by respective edges. Each of the edges connects logically, in the edge network, respective two of the edge nodes directly with each other such that each of the edges terminates logically at the respective two edge nodes without any intermediate edge node.

In response to determining that the first edge node receives the cache request (S110=yes), the means for calculating 120 calculates at least one of the following (S120): a lifetime for the data, or a maximum topological distance. The maximum topological distance is calculated such that the data must not be transmitted from the first edge node in the edge network farther than the maximum topological distance in a direction away from the first edge node.

The means for transmitting 130 transmits the data along with the at least one of the maximum topological distance and the lifetime calculated in S120 (S130). The transmission is via a first edge of the edge network to the second edge node of the edge network. According to a stored topology of the edge network, the first edge terminates at the first edge node and the second edge node. I.e., the first edge node and the second edge node are direct neighbors in the edge network.

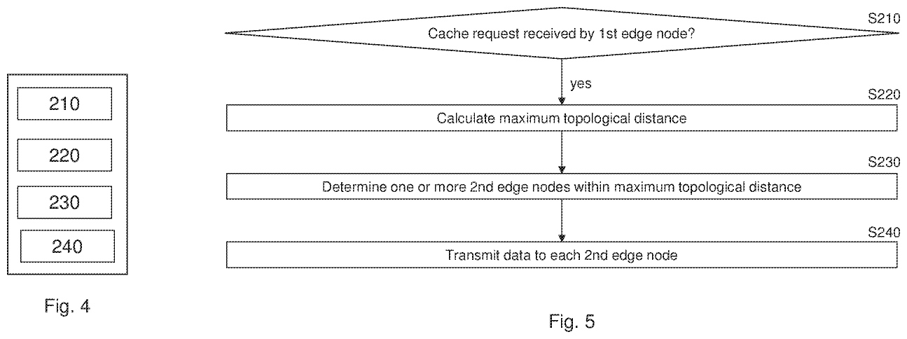

FIG. 4 shows an apparatus according to an example embodiment of the invention. The apparatus may be a cache unit or an element thereof (such as a control unit of the cache unit). FIG. 5 shows a method according to an example embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus includes first means for determining 210, means for calculating 220, second means for determining 230, and means for transmitting 240. The first means for determining 210, means for calculating 220, second means for determining 230, and means for transmitting 240 may be a first determining means, calculating means, second determining means, and transmitting means, respectively. The first means for determining 210, means for calculating 220, second means for determining 230, and means for transmitting 240 may be a first determiner, calculator, second determiner, and transmitter, respectively. The first means for determining 210, means for calculating 220, second means for determining 230, and means for transmitting 240 may be a first determining processor, calculating processor, second determining processor, and transmitting processor, respectively.

The first means for determining 210 determines whether a first edge node of an edge network receives a cache request (S210). The cache request requests the first edge node to cache data received from a movable device. The edge network connects a plurality of edge nodes including the first edge node and one or more second edge nodes by respective edges. Each of the edges connects logically, in the edge network, respective two of the edge nodes directly with each other such that each of the edges terminates logically at the respective two edge nodes without any intermediate edge node.

In response to determining that the first edge node receives the cache request (S210=yes), the means for calculating 220 calculates a maximum topological distance (S220). The maximum topological distance is calculated such that the data must not be transmitted from the first edge node in the edge network farther than the maximum topological distance in a direction away from the first edge node.

The second means for determining 230 determines the one or more second edge nodes (S230). According to a stored topology of the edge network, each of the one or more second edge nodes is not farther away from the first edge node than the maximum topological distance. The means for transmitting 240 transmits the data to each of the second edge nodes (S240).

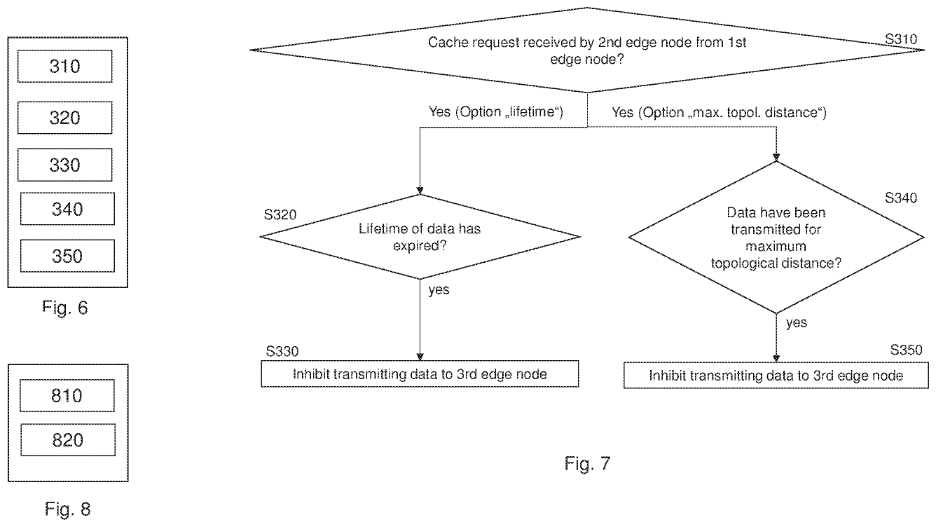

FIG. 6 shows an apparatus according to an example embodiment of the invention. The apparatus may be a cache unit or an element thereof (such as a control unit of the cache unit). FIG. 7 shows a method according to an example embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus includes first means for determining 310, second means for determining 320, first means for inhibiting 330, third means for determining 340, and second means for inhibiting 350. The first means for determining 310, second means for determining 320, first means for inhibiting 330, third means for determining 340, and second means for inhibiting 350 may be a first determining means, second determining means, first inhibiting means, third determining means, and second inhibiting means, respectively. The first means for determining 310, second means for determining 320, first means for inhibiting 330, third means for determining 340, and second means for inhibiting 350 may be a first determiner, second determiner, first inhibiter, third determiner, and second inhibiter, respectively. The first means for determining 310, second means for determining 320, first means for inhibiting 330, third means for determining 340, and second means for inhibiting 350 may be a first determining processor, second determining processor, first inhibiting processor, third determining processor, and second inhibiting processor, respectively.

The first means for determining 310 determines whether a second edge node of an edge network receives a cache request transmitted from a first edge node via a first edge (S310). The edge network connects a plurality of edge nodes including the first edge node and the second edge node by respective edges including the first edge and a second edge. Each of the edges connects logically, in the edge network, respective two of the edge nodes directly with each other such that each of the edges terminates logically at the respective two edge nodes without any intermediate edge node. The first edge terminates at the first edge node and the second edge node. I.e., the first edge node and the second edge nodes are direct neighbors in the edge network. The second edge terminates at the second edge node and a third edge node different from the first edge node.

The cache request comprises data related to a movable device and at least one of the following: a lifetime of the data, or a maximum topological distance. The maximum topological distance indicates that the data must not be transmitted from the first edge node in the edge network farther than the maximum topological distance in a direction away from the first edge node.

In response to determining that the second edge node receives the cache request comprising the lifetime (S310=yes for the option “lifetime”), the second means for determining 320 determines whether the lifetime of the data has expired (S320).

In response to determining that the second edge node receives the cache request comprising the lifetime (S310=yes for the option “lifetime”) and that the lifetime of the data has expired (S320=yes), the first means for inhibiting 330 inhibits transmitting the data via the second edge (S330).

In response to determining that the second edge node receives the cache request comprising the maximum topological distance (S310=yes for the option “maximum topological distance”), the third means for determining 340 determines whether the maximum topological distance indicates that the data have been transmitted for the maximum topological distance by the transmitting the data from the first edge node via the first edge. I.e., the third means for determining 340 determines whether the data have reached the maximum topological distance due to the last transmission from the first edge node via the first edge to the second edge node.

In response to determining that the second edge node receives the cache request comprising the maximum topological distance (S310=yes for the option “maximum topological distance”) and that the greatest number of edges indicates that the data have been transmitted for the maximum topological distance by the transmitting the data from the first edge node via the first edge (S340=yes), the second means for inhibiting 350 inhibits the transmitting the data via the second edge (S350).

In some example embodiments, if the determining of S310 is affirmative for both of the options “lifetime” and “maximum topological distance”), the determining of S320 may be performed prior to the determining of S340. In this case, in some example embodiments, if the determining in S320 is affirmative, the determining of S340 and the inhibiting of S350 may be omitted.

In some example embodiments, if the determining of S310 is affirmative for both of the options “lifetime” and “maximum topological distance”, the determining of S340 may be performed prior to the determining of S320. In this case, in some example embodiments, if the determining in S340 is affirmative, the determining of S320 and the inhibiting of S330 may be omitted.

In some example embodiments, if the determining of S310 is affirmative for both of the options “lifetime” and “maximum topological distance”), the determining of S320 and the determining of S340 may be performed fully or partly in parallel.

In some example embodiments, if neither of the determinations of S320 and S340 is affirmative, the apparatus may perform at least one: caching the data in a cache of the second edge node, or transmitting the data to the third edge node along with the lifetime or a new maximum topological distance, respectively. The new maximum topological distance is obtained from the received maximum topological distance, if any, by subtracting the topological distance of the first edge from the received maximum topological distance.

FIG. 8 shows an apparatus according to an example embodiment of the invention. The apparatus comprises at least one processor 810, at least one memory 820 storing instructions that, when executed by the at least one processor 810, cause the apparatus at least to perform the method according to at least one of the following figures and related description: FIG. 3, or FIG. 5, or FIG. 7.

Some example embodiments are explained for vehicles on roads. However, vehicles are just examples of movable devices. Other examples of movable devices to which the present disclosure may be applied are pallets in digital factories, ships or containers in harbors, etc.

Some example embodiments are explained with respect to a 5G network for transmitting the vehicle-to-edge data from the vehicle to the edge node. However, some example embodiments may use other communication networks, e.g. previous or forthcoming generations of 3GPP networks such as 4G, 6G, or 7G, etc. They may use non-3GPP mobile communication networks.

One piece of information may be transmitted in one or plural messages from one entity to another entity. Each of these messages may comprise further (different) pieces of information. Names of network elements, network functions, protocols, and methods are based on current standards. In other versions or other technologies, the names of these network elements and/or network functions and/or protocols and/or methods may be different, as long as they provide a corresponding functionality. The same applies correspondingly to the terminal.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments provide, for example, an cache unit or a component thereof (such as a control unit of the cache unit), an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments. However, it should be noted that the description of the preferred example embodiments is given by way of example only and that various modifications may be made without departing from the scope of the invention as defined by the appended claims.

The terms “first X” and “second X” include the options that “first X” is the same as “second X” and that “first X” is different from “second X”, unless otherwise specified. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

ABBREVIATIONS

| | |
|---|---|
| 3GPP | 3^{rd} Generation Partnership Project |
| 5G/6G/7G | 5^{th}/6^{th}/7^{th} Generation |
| ETSI | European Telecommunications Standards Institute |
| ID | Identifier |
| ITS | Intelligent Transport System |
| LUT | Look Up Table |
| TS | Technical Specification |

1-38. (canceled)

39. Apparatus comprising:
one or more processors, and memory storing instructions that, when executed by the one or more processors, cause the apparatus to perform:
determining whether a first edge node of an edge network receives a cache request, wherein the cache request requests the first edge node to cache data received from a movable device;
in response to determining that the first edge node receives the cache request: calculating a maximum topological distance such that the data must not be transmitted from the first edge node in the edge network farther than the maximum topological distance in a direction away from the first edge node;
determining one or more second edge nodes, wherein, according to a stored topology of the edge network, each of the one or more second edge nodes is not farther away from the first edge node than the maximum topological distance;
transmitting the data to each of the second edge nodes, wherein
the edge network connects a plurality of edge nodes including the first edge node and the one or more second edge nodes by respective edges;
each of the edges connects logically, in the edge network, respective two of the edge nodes directly with each other such that each of the edges terminates logically at the respective two edge nodes without any intermediate edge node.

40. The apparatus according to claim 39, wherein the instructions, when executed by the one or more processors, cause the apparatus to perform:
the determining the one or more second edge nodes by determining all the second edge nodes, wherein, according to the stored topology, each of all the second edge nodes is not farther away from the first edge node than the maximum topological distance.

41. The apparatus according to claim 39, wherein the instructions, when executed by the one or more processors, further cause the apparatus to perform:
calculating a lifetime of the data in response to determining that the first edge node receives the cache request;
transmitting the lifetime along with the data to each of the second edge nodes.

42. The apparatus according to claim 39, wherein the instructions, when executed by the one or more processors, further cause the apparatus to perform:
caching the data in a cache of the first edge node in response to determining that the first edge node receives the cache request.

43. The apparatus according to claim 39, wherein the instructions, when executed by the one or more processors, further cause the apparatus to perform:
determining whether the lifetime of the data has expired; and at least one of the following:
inhibiting the caching the data in the cache of the first edge node in response to determining that the lifetime of the data has expired, or
removing the data from the cache of the first edge node in response to determining that the lifetime of the data has expired.

44. The apparatus according to claim 39, wherein the instructions, when executed by the one or more processors, cause the apparatus to perform:
the calculating the maximum topological distance based on at least one of: a status of the movable device or a status of an environment of the movable device.

45. The apparatus according to claim 44, wherein the status of the movable device comprises at least one of the following: a location of the movable device, a current speed of the movable device, or a previous speed of the movable device, or a current acceleration of the movable device, or a previous acceleration of the movable device.

46. The apparatus according to claim 45, wherein the status of the environment of the movable device comprises at least one of the following: a current congestion level at the location of the movable device, or a current congestion level on a route predicted for the movable device, or a previous congestion level at the location of the movable device, or a previous congestion level on the route predicted for the movable device, or an expected congestion level on the route predicted for the movable device, or an admissible speed at the location of the movable device, or an admissible speed on the route predicted for the movable device.

47. The apparatus according to claim 39, wherein the instructions, when executed by the one or more processors, further cause the apparatus to perform:
determining whether the maximum topological distance is smaller than a topological distance to the second edge node from the first edge node, wherein, according to the stored topology, the second edge node is a nearest neighbor of the first edge node;
inhibiting the transmitting the data in response to determining that the maximum topological distance is smaller than the topological distance to the second edge node from the first edge node.

48. The apparatus according to claim 39, wherein the instructions, when executed by the one or more processors, further cause the apparatus to perform:
determining whether the lifetime of the data has expired;
inhibiting the transmitting the data in response to determining that the lifetime of the data has expired.

49. Method comprising:
determining whether a first edge node of an edge network receives a cache request, wherein the cache request requests the first edge node to cache data received from a movable device;
in response to determining that the first edge node receives the cache request: calculating a maximum topological distance such that the data must not be transmitted from the first edge node in the edge network farther than the maximum topological distance in a direction away from the first edge node;
determining one or more second edge nodes, wherein, according to a stored topology of the edge network, each of the one or more second edge nodes is not farther away from the first edge node than the maximum topological distance;
transmitting the data to each of the second edge nodes, wherein
the edge network connects a plurality of edge nodes including the first edge node and the one or more second edge nodes by respective edges;
each of the edges connects logically, in the edge network, respective two of the edge nodes directly with each other such that each of the edges terminates logically at the respective two edge nodes without any intermediate edge node.

50. The method according to claim 49, wherein
the determining the one or more second edge nodes is performed by determining all the second edge nodes, wherein, according to the stored topology, each of all the second edge nodes is not farther away from the first edge node than the maximum topological distance.

51. The method according to claim 49, further comprising:
calculating a lifetime of the data in response to determining that the first edge node receives the cache request;
transmitting the lifetime along with the data to each of the second edge nodes.

52. The method according to claim 49, further comprising:
caching the data in a cache of the first edge node in response to determining that the first edge node receives the cache request.

53. The method according to claim 52, further comprising:
determining whether the lifetime of the data has expired; and at least one of the following:
inhibiting the caching the data in the cache of the first edge node in response to determining that the lifetime of the data has expired, or
removing the data from the cache of the first edge node in response to determining that the lifetime of the data has expired.

54. The method according to claim 49, wherein
the maximum topological distance is calculated based on at least one of: a status of the movable device or a status of an environment of the movable device.

55. The method according to claim 54, wherein the status of the movable device comprises at least one of the following: a location of the movable device, a current speed of the movable device, or a previous speed of the movable device, or a current acceleration of the movable device, or a previous acceleration of the movable device.

56. The method according to any of claim 54, wherein the status of the environment of the movable device comprises at least one of the following: a current congestion level at the location of the movable device, or a current congestion level on a route predicted for the movable device, or a previous congestion level at the location of the movable device, or a previous congestion level on the route predicted for the movable device, or an expected congestion level on the route predicted for the movable device, or an admissible speed at the location of the movable device, or an admissible speed on the route predicted for the movable device.

57. The method according to claim 49, further comprising:
determining whether the maximum topological distance is smaller than a topological distance to the second edge node from the first edge node, wherein, according to the stored topology, the second edge node is a nearest neighbor of the first edge node;
inhibiting the transmitting the data in response to determining that the maximum topological distance is smaller than the topological distance to the second edge node from the first edge node.

58. Method comprising:
determining whether a second edge node of an edge network receives a cache request transmitted from a first edge node via a first edge, wherein
the edge network connects a plurality of edge nodes including the first edge node and the second edge node by respective edges including the first edge and a second edge;
each of the edges connects logically, in the edge network, respective two of the edge nodes directly with each other such that each of the edges terminates logically at the respective two edge nodes without any intermediate edge node;
the first edge terminates at the first edge node and the second edge node;
the second edge terminates at the second edge node and a third edge node different from the first edge node;
the cache request comprises data related to a movable device and at least one of the following: a lifetime of the data, or a maximum topological distance, wherein the data must not be transmitted from the first edge node in the edge network farther than the maximum topological distance in a direction away from the first edge node;
and the method further comprises:
determining whether the lifetime of the data has expired in response to determining that the second edge node receives the cache request comprising the lifetime;
inhibiting transmitting the data via the second edge in response to determining that the second edge node receives the cache request comprising the lifetime and that the lifetime of the data has expired;
determining whether the maximum topological distance indicates that the data have been transmitted for the maximum topological distance by the transmitting the data from the first edge node via the first edge in response to determining that the second edge node receives the cache request comprising the maximum topological distance;
inhibiting the transmitting the data via the second edge in response to determining that the second edge node receives the cache request comprising the maximum topological distance and that the greatest number of edges indicates that the data have been transmitted for the maximum topological distance by the transmitting the data from the first edge node via the first edge.
